(19) United States
(12) Patent Application Publication
(10) Pub. No.: US 2021/0224329 A1
(43) Pub. Date: Jul. 22, 2021

(54) ACTION TO RETRIEVE DATA FROM EXTERNAL DATA SOURCE FOR USE IN SEQUENCE OF OPERATIONS PERFORMED BY CUSTOMER RELATIONSHIP MANAGEMENT SYSTEM

(71) Applicant: salesforce.com, inc., San Francisco, CA (US)

(72) Inventors: Catherine Schell, San Francisco, CA (US); Samuel William Bailey, Cardiff (GB)

(21) Appl. No.: 16/748,186

(22) Filed: Jan. 21, 2020

(51) Int. Cl. G06F 16/9038; G06Q 30/06; G06F 16/904

(52) U.S. Cl. CPC G06F 16/9038; G06F 16/904; G06Q 30/0627

(57) ABSTRACT

A processor can produce an action to retrieve data from an external data source. The processor can cause an object to be defined to reference an attribute that is defined in the external data source, lacks being defined in a database subsystem, and has a data type to be passed by reference rather than by value. The processor can cause the action to be defined to include an identification of the external data source, an identification of an input parameter for the action, and an identification of an output parameter for the action. A name of the object can be a value for the output parameter. The processor can be configured to operate a customer relationship management system having the database subsystem and a business process subsystem. The action can be associated with a sequence of operations to be processed by the business process subsystem.

### BACKGROUND

An application to process a sequence of operations can be executed on a processor. The processor can cause operation tracking screens to be presented on a display. At least some of the operation tracking screens can have graphical control elements configured to receive information associated with actions associated with the sequence of operations. The processor can receive signals associated with the information associated with the actions associated with the sequence of operations. The processor can cause, in response to the signals, the sequence of operations to be processed.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementation of the disclosed subject matter. No attempt is made to show structural details in more detail than may be necessary for a fundamental understanding of the disclosed subject matter and the various ways in which it can be practiced.

FIG. 1 is a diagram illustrating an example of an environment for a system for producing an action to retrieve data from an external data source and for retrieving the data from the external data source, according to the disclosed technologies.

FIG. 2 is a flow diagram illustrating an example of a method for producing an action to retrieve data from an external data source, according to the disclosed technologies.

FIG. 3 is a diagram illustrating an example of an object design screen, according to the disclosed technologies.

FIG. 4 is a diagram illustrating an example of an operation tracking design screen, according to the disclosed technologies.

FIG. 5 is a flow diagram illustrating an example of a method for causing the action to retrieve data to be defined, according to the disclosed technologies.

FIGS. 6A and 6B are a flow diagram illustrating an example of a method for retrieving data from an external data source, according to the disclosed technologies.

FIG. 7 is a diagram illustrating an example of a first operation tracking screen, according to the disclosed technologies.

FIG. 8 is a flow diagram illustrating an example of a method for receiving a signal that indicates a value of an input parameter for an action, according to the disclosed technologies.

FIG. 9 is a diagram illustrating a first example of a second operation tracking screen, according to the disclosed technologies.

FIG. 10 is a flow diagram illustrating an example of a method for causing first data to be presented, according to the disclosed technologies.

FIG. 11 is a diagram illustrating a second example of the second operation tracking screen, according to the disclosed technologies.

FIG. 12 is a flow diagram illustrating an example of a method for causing second data to be presented, according to the disclosed technologies.

### DETAILED DESCRIPTION

As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation.

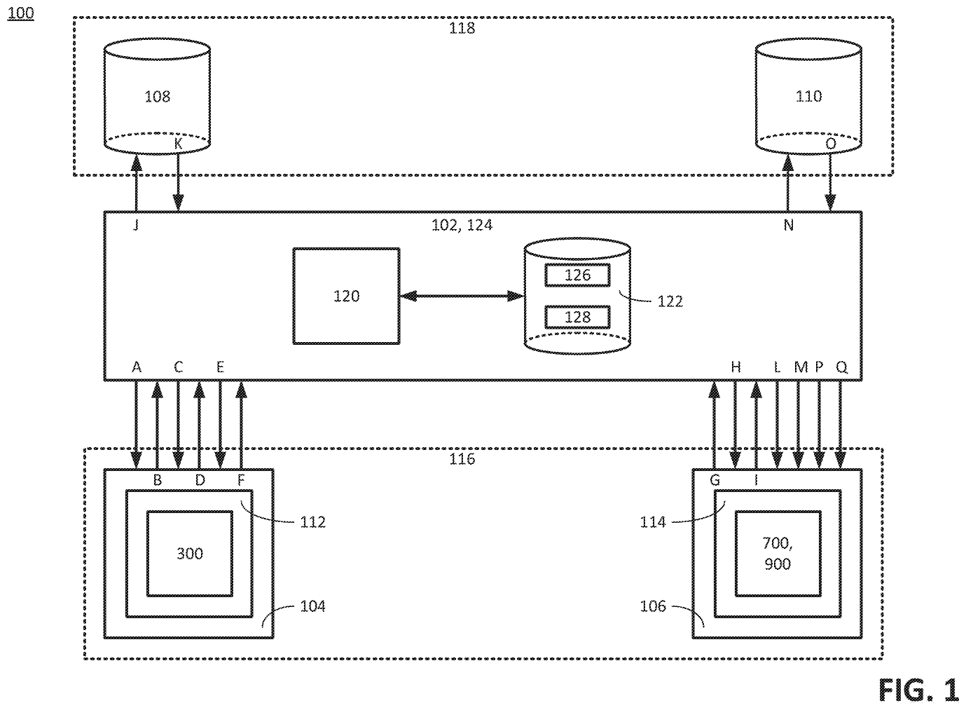

FIG. 1 is a diagram illustrating an example of an environment 100 for a system 102 for producing an action to retrieve data from an external data source and for retrieving the data from the external data source, according to the disclosed technologies. The environment 100 can include, for example, the system 102, a first user device 104, a second user device 106, a first external data source 108, and a second external data source 110. The first user device 104 can include, for example, a first display 112. The second user device 106 can include, for example, a second display 114. Alternatively, a function of the second user device 106 and a function of the first user device 104 can be incorporated into a user device 116. Alternatively, a function of the first external data source 108 and a function of the second external data source 110 can be incorporated into an external data source 118. The system 102 can include, for example, a processor 120 and a memory 122. The system 102 can be, for example, a customer relationship management system 124. The processor 120 can be configured to operate the customer relationship management system 124. The customer relationship management system 124 can have, for example, a database subsystem 126 and a business process subsystem 128. The database subsystem 126 can include, for example, a multitenant database. The action to retrieve data can be associated with a sequence of operations to be processed by the business process subsystem 128.

For illustrative purposes herein, the sequence of operations can be for retrieving data about vintage cars for an entity that sells the vintage cars. In the illustrative example: (1) information about potential buyers of the vintage cars can be stored in the database subsystem 126 and (2) information about the vintage cars can be stored in the first external data source 108. In the illustrative example, the database subsystem 126 can include data associated with attributes such as a “name” of a potential buyer, a “contact information” associated with the name, and an indication that a person associated with the name has an “interest in vintage cars”. In the illustrative example, the first external data source 108 can include data associated with attributes such as a “make” of a car, a “model” of the car, a “color” of the car, a “year” the car was made, a “price” for the car, and a vehicle information number (“VIN”) for the car. In the illustrative example, the first external data source 108 can be associated with an entity known as “VintageAuto”. In the illustrative example, information about engines associated with cars can be stored in the second external data source 110. In the illustrative example, the second external data source 110 can include data associated with attributes such as the “VIN” for the car, a “cylinder” configuration of an engine for the car, a “volume” of cylinders of the engine, and a “power” of the engine. In the illustrative example, the second external data source 110 can be associated with an entity known as “EngineSpecs”.

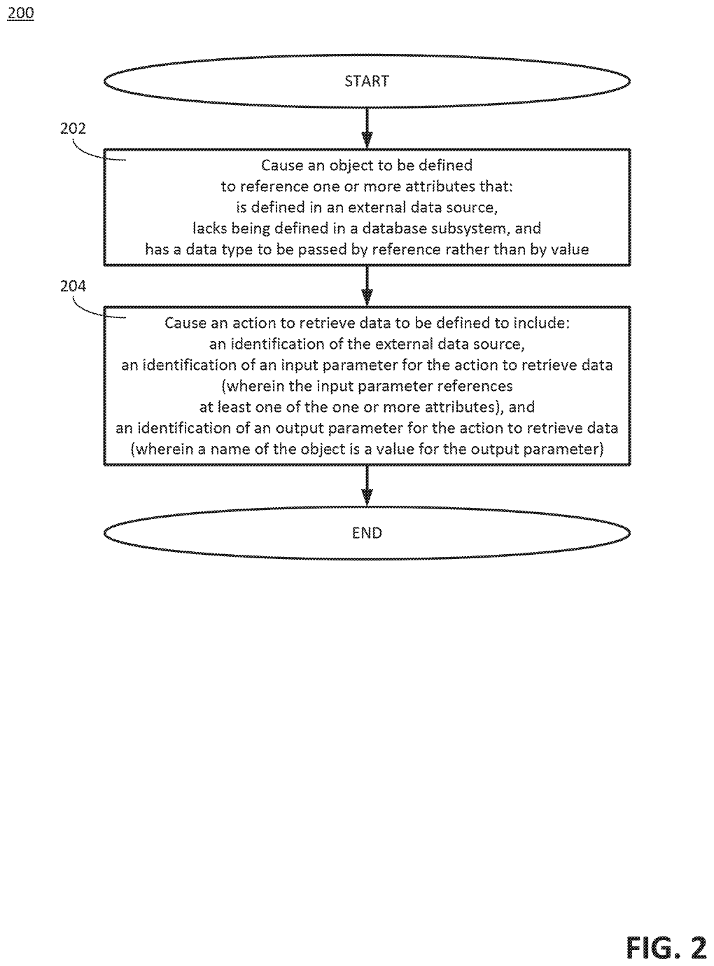

FIG. 2 is a flow diagram illustrating an example of a method 200 for producing an action to retrieve data from an external data source, according to the disclosed technologies.

With reference to FIGS. 1 and 2, in the method 200, at an operation 202, the processor 120 can be configured to cause an object to be defined to reference one or more attributes. The one or more attributes can be defined in the external data source 118. The one or more attributes can lack being defined in the database subsystem 126. The one or more attributes can have a data type to be passed by reference rather than by value.

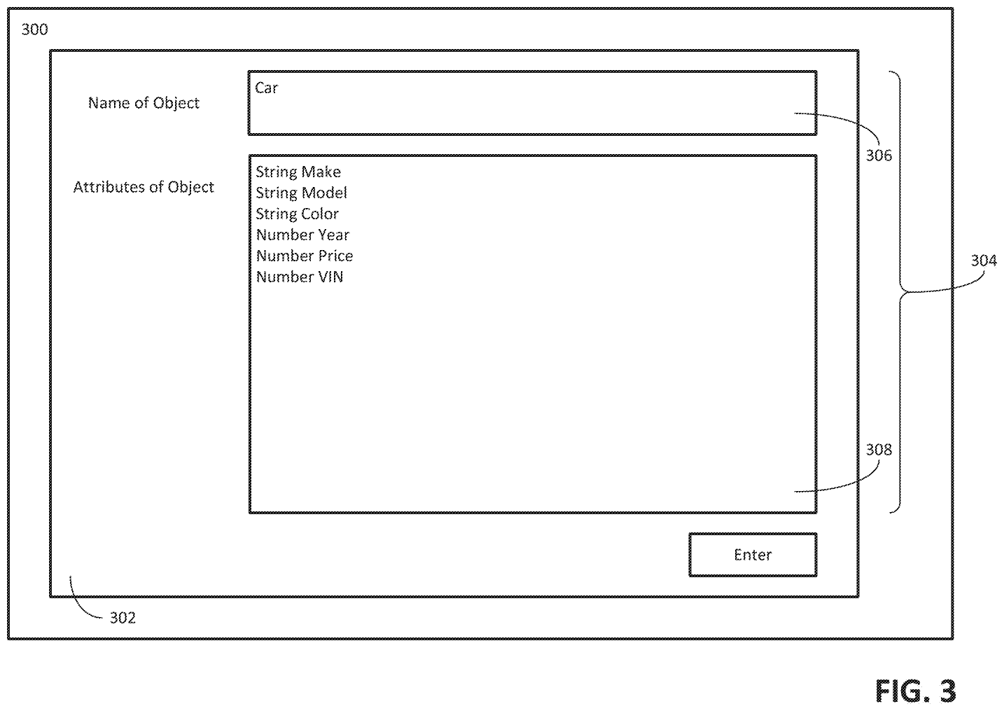

FIG. 3 is a diagram illustrating an example of an object design screen 300, according to the disclosed technologies. The object design screen 300 can be, for example, for a user interface 302. The user interface 302 can have graphical control elements 304 configured to receive information to define the object. The graphical control elements 304 can include, for example, one or more of a button, a radio button, a check box, a split button, a cycle button, a slider, a list box, a spinner, a drop-down list, a menu, a context menu, a pie menu, a menu bar, a tool bar, a ribbon, a combo box, a text box, or the like. For example, the graphical control elements 304 can include a first text box 306 and a second text box 308. A name of the object (e.g., Car) can be received by the first text box 306. The attributes referenced by the object (e.g., make, model, color, year, price, and VIN) can be received by the second text box 308.

Returning to FIGS. 1 and 2, in the method 200, at an operation 204, the processor 120 can be configured to cause the action to retrieve data to be defined. A definition of the action to retrieve data can include an identification of the external data source 118. The definition of the action to retrieve data can include an identification of an input parameter for the action to retrieve data. The input parameter can reference one or more of the one or more attributes. The definition of the action to retrieve data can include an identification of an output parameter for the action to retrieve data. A name of the object can be a value for the output parameter.

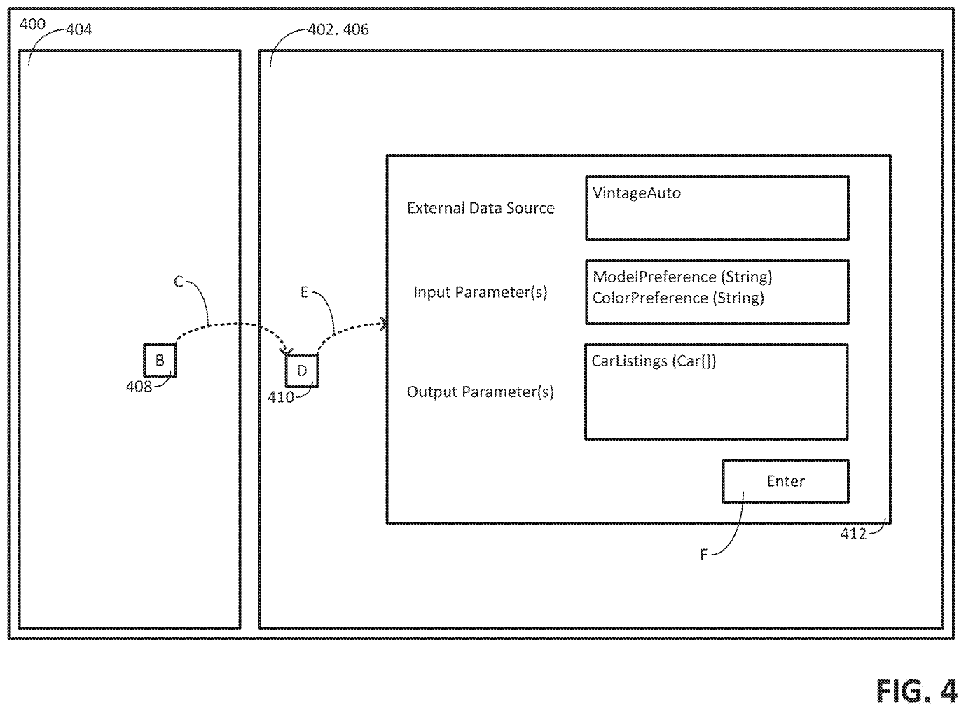

FIG. 4 is a diagram illustrating an example of an operation tracking design screen 400, according to the disclosed technologies. The operation tracking design screen 400 can include, for example, a first screen area 402 and a second screen area 404. The first screen area 402 can be a canvas graphical user interface 406. The second screen area 404 can include a graphical control element 408 configured to cause, in response to being selected, a graphical representation 410 to appear in the first screen area 402. The graphical control element 408 can be associated with the action to retrieve data. A description of an operation tracking design screen is provided in U.S. Patent Application Pub. No. 2020/0019300, filed Jul. 16, 2018, the disclosure of which is incorporated herein in its entirety by reference.

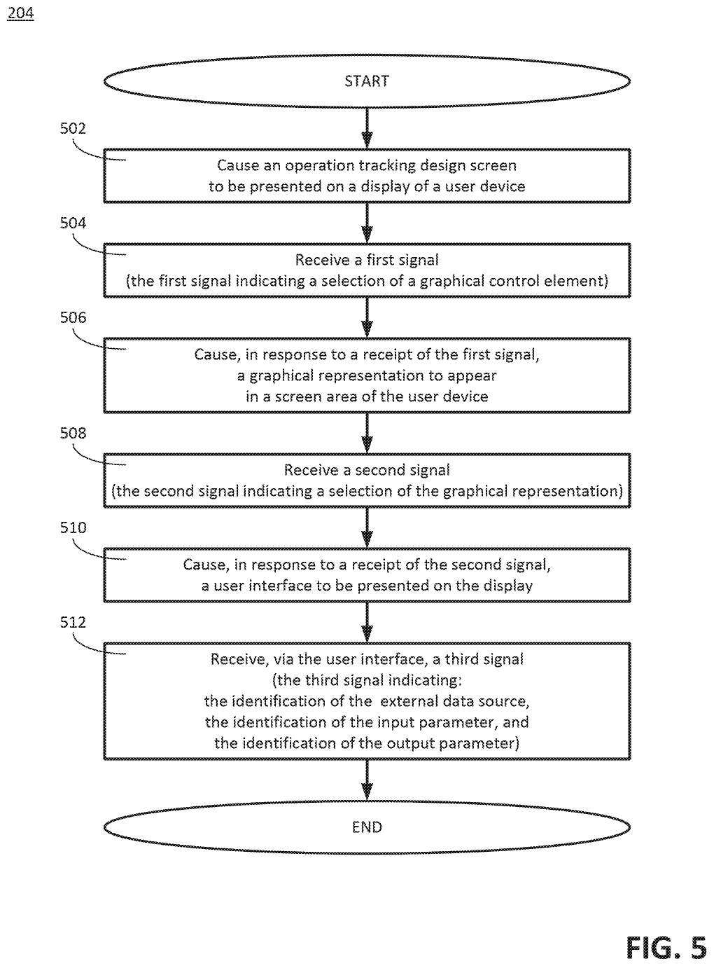

FIG. 5 is a flow diagram illustrating an example of a method 204 for causing the action to retrieve data to be defined, according to the disclosed technologies.

With reference to FIGS. 1, 4, and 5, in the method 204, at an operation 502, the processor 120 can be configured to cause (A) the operation tracking design screen 400 to be presented on the first display 112 of the first user device 104.

At an operation 504, the processor 120 can be configured to receive (B) a first signal. The first signal can indicate a selection of the graphical control element 408.

At an operation 506, the processor 120 can be configured to cause (C), in response to a receipt of the first signal, the graphical representation 410 to appear in the first screen area 402.

At an operation 508, the processor 120 can be configured to receive (D) a second signal. The second signal can indicate a selection of the graphical representation 410.

At an operation 510, the processor 120 can be configured to cause (E), in response to a receipt of the second signal, a user interface 412 to be presented on the first display 112.

At an operation 512, the processor 120 can be configured to receive (F), via the user interface 412, a third signal. The third signal can indicate: (1) the identification of the first external data source 108 (e.g., VintageAuto), (2) the identification of the input parameter (e.g., ModelPreference (String) and ColorPreference (String)), and (3) the identification of the output parameter (e.g., CarListings (Car[ ])).

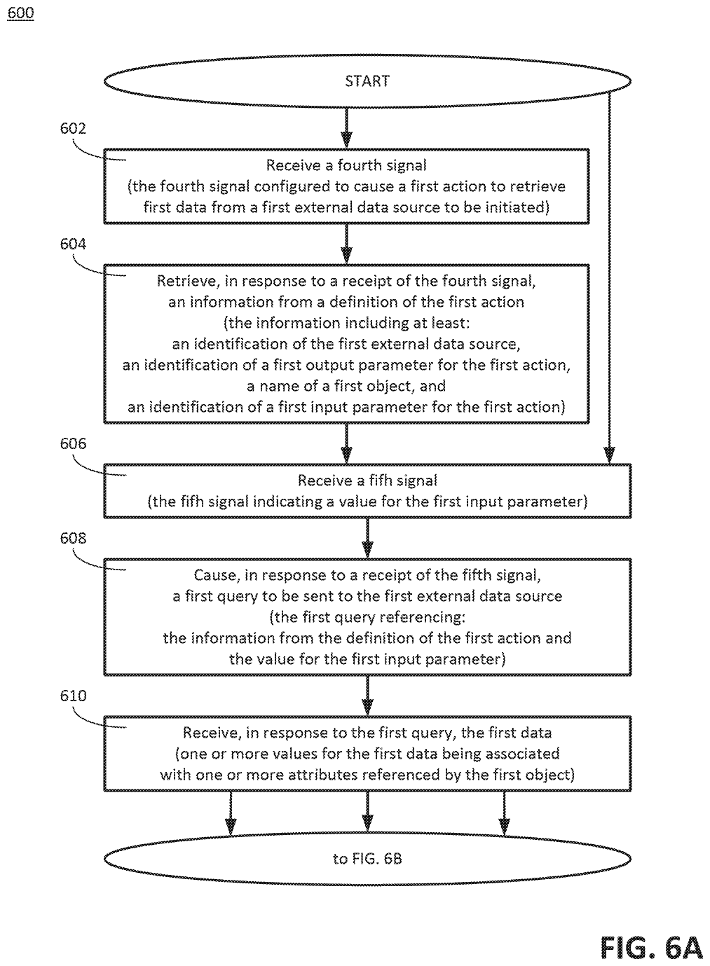

FIGS. 6A and 6B are a flow diagram illustrating an example of a method 600 for retrieving data from an external data source, according to the disclosed technologies.

With reference to FIGS. 1 and 6A, in the method 600, at an operation 602, the processor 120 can be configured to receive (G) a fourth signal. The fourth signal can be configured to cause a first action to retrieve first data from the first external data source 108 to be initiated.

At an operation 604, the processor 120 can be configured to retrieve, in response to a receipt of the fourth signal, an information from a definition of the first action. The definition of the first action can include an identification of first external data source 108. The definition of the first action can include an identification of a first output parameter for the first action. A name of a first object can be a value for the first output parameter. The first object can be defined to reference one or more first attributes. The one or more first attributes can be defined in the first external data source 108. The one or more first attributes can lack being defined in the database subsystem 126. The one or more first attributes can have a data type to be passed by reference rather than by value. The definition of the first action can include an identification of a first input parameter for the first action. The first input parameter can reference one or more of the one or more first attributes. The information from the definition of the first action can include at least: (1) the identification of the first external data source 108 (e.g., VintageAuto), (2) the identification of the first output parameter (e.g., CarListings (Car[ ])), (3) the name of the first object (e.g., Car[ ]), and (4) the identification of the first input parameter (e.g., ModelPreference (String) and ColorPreference (String)).

At an operation 606, the processor 120 can be configured to receive a fifth signal. The fifth signal can indicate a value for the first input parameter.

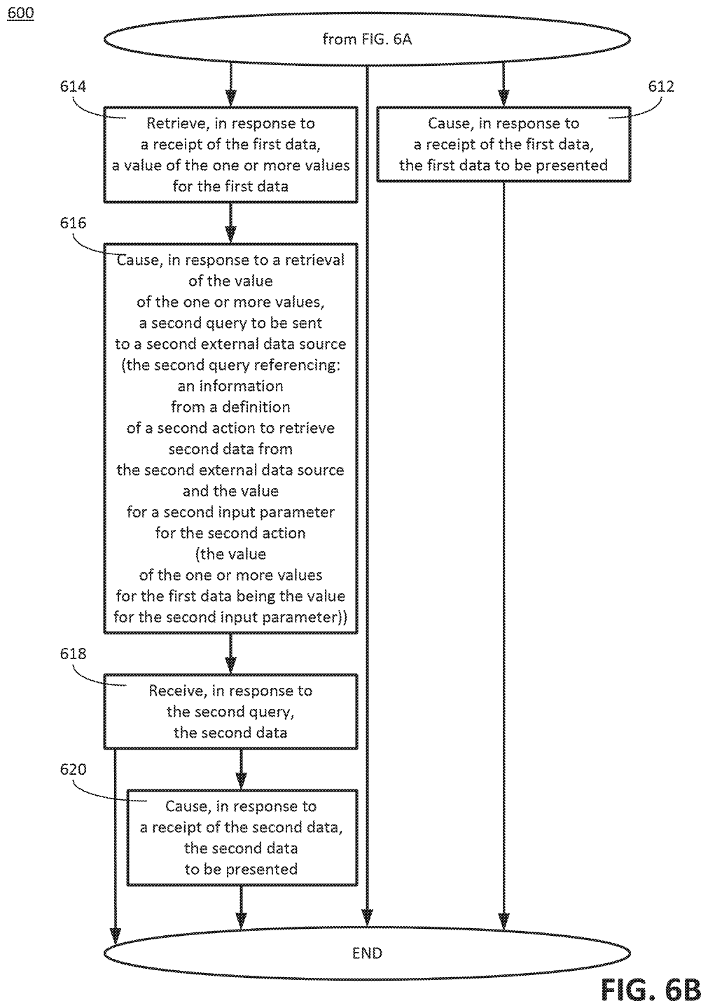

FIG. 7 is a diagram illustrating an example of a first operation tracking screen 700, according to the disclosed technologies. The first operation tracking screen 700 can include, for example, a graphical control element 702 configured to receive the value of the first input parameter. A description of an operation tracking screen is provided in U.S. Patent Application No. 2020/0019300, filed Jul. 16, 2018, the disclosure of which is incorporated herein in its entirety by reference.

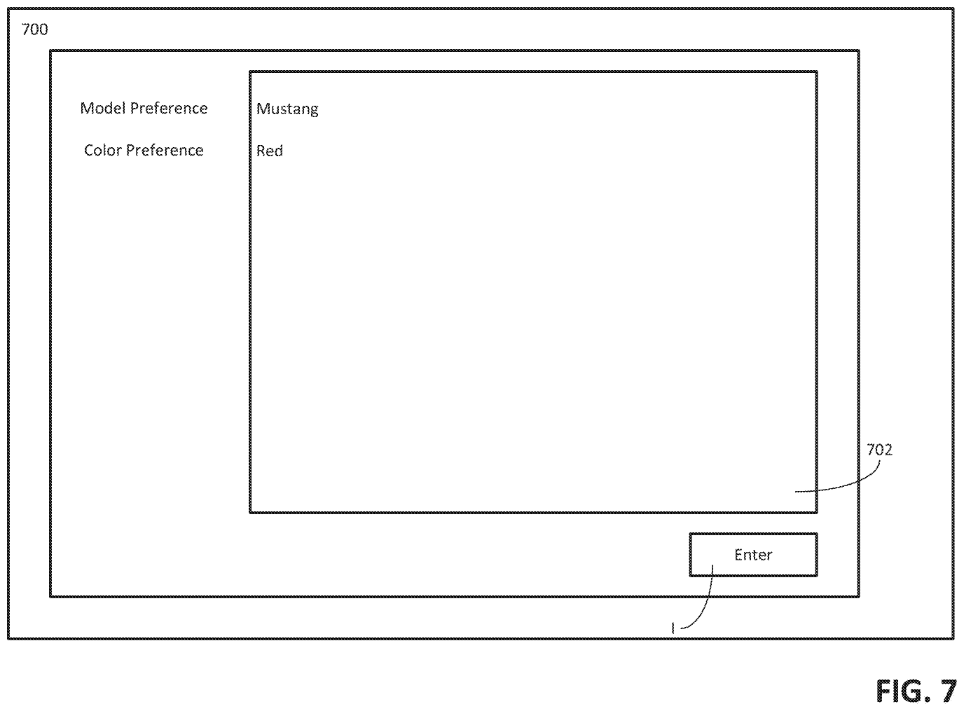

FIG. 8 is a flow diagram illustrating an example of a method 606 for receiving a signal that indicates a value of an input parameter for an action, according to the disclosed technologies.

With reference to FIGS. 1, 7, and 8, in the method 606, at an operation 802, the processor 120 can be configured to cause (H) the first operation tracking screen 700 to be presented on the second display 114 of the second user device 106.

At an operation 804, the processor 120 can be configured to receive (I), via the graphical control element 702, the fifth signal. The fifth signal can indicate the value (e.g., respectively, “Mustang” and “red”) for the first input parameter (e.g., respectively, ModelPreference (String) and ColorPreference (String)).

Returning to FIGS. 1 and 6A, in the method 600, at an operation 608, the processor 120 can be configured to cause (J), in response to a receipt of the fifth signal, a first query to be sent to the first external data source 108. The first query can reference: (1) the information from the definition of the first action and (2) the value for the first input parameter.

At an operation 610, the processor 120 can be configured to receive (K), in response to the first query, the first data. One or more values for the first data can be associated with the one or more first attributes.

With reference to FIGS. 1 and 6B, in the method 600, additionally, for example, at an operation 612, the processor 120 can be configured to cause, in response to a receipt of the first data, the first data to be presented.

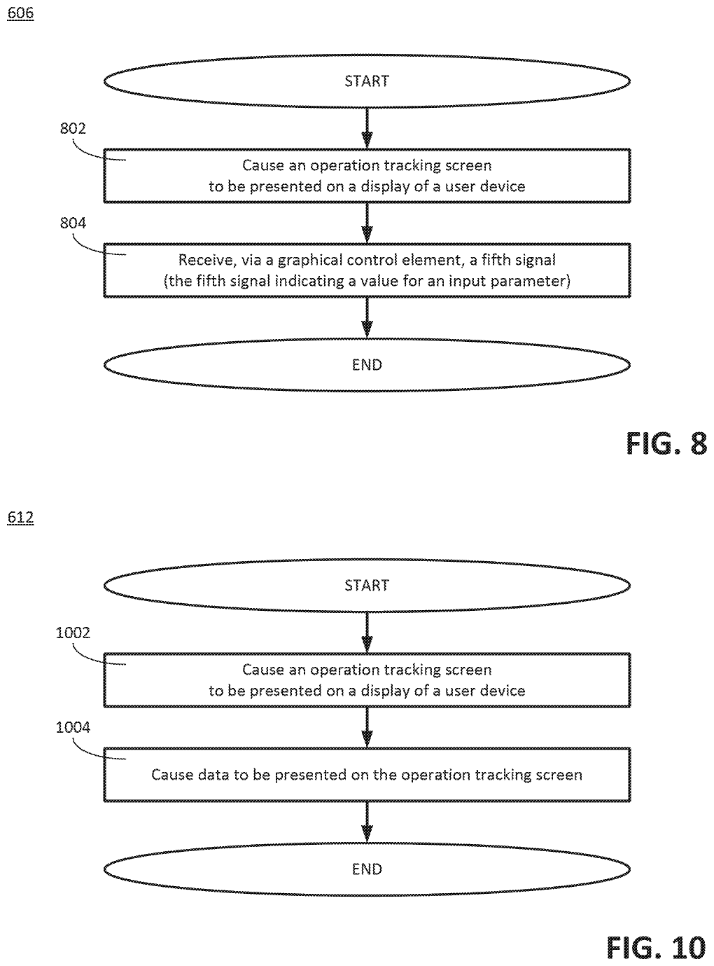

FIG. 9 is a diagram illustrating a first example of a second operation tracking screen 900, according to the disclosed technologies.

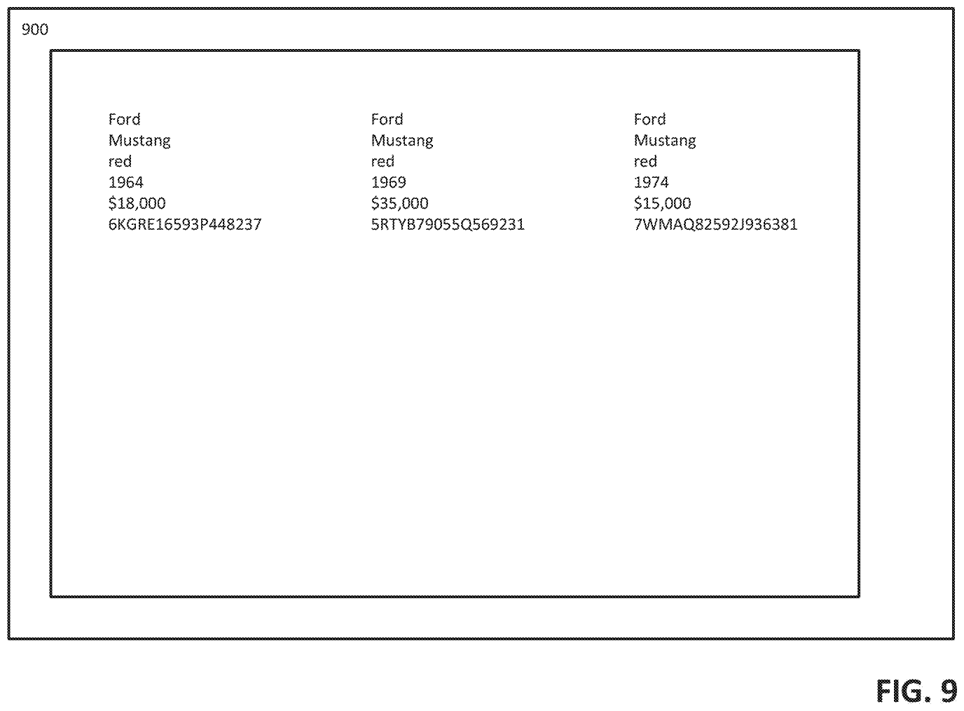

FIG. 10 is a flow diagram illustrating an example of a method 612 for causing first data to be presented, according to the disclosed technologies.

With reference to FIGS. 1, 9, and 10, in the method 612, at an operation 1002, the processor 120 can be configured to cause (L) the second operation tracking screen 900 to be presented on the second display 114 of the second user device 106.

At an operation 1004, the processor 120 can be configured to cause (M) the first data to be presented on the second operation tracking screen 900. For illustrative purposes herein, the first data can be for three vintage cars. In the illustrative example, the one or more first attributes associated with the first data can include the make of a car, the model of the car, the color of the car, the year the car was made, the price for the car, and the VIN for the car. In the illustrative example, the one or more values for the first data can include: (1) for a first car, the make (Ford), the model (Mustang), the color (red), the year (1964), the price ($18,000), and the VIN (6KGRE16593P448237); (2) for a second car, the make (Ford), the model (Mustang), the color (red), the year (1969), the price ($35,000), and the VIN (5RTYB79055Q569231); and (3) for a third car, the make (Ford), the model (Mustang), the color (red), the year (1974), the price ($15,000), and the VIN (7WMAQ82592J936381).

Having an action to retrieve data from an external data source defined to include a name of an object, the object defined to reference one or more attributes, as a value of an output parameter for the action can allow a single action to be used to retrieve multiple items of information (e.g., for the first car, the make (Ford), the model (Mustang), the color (red), the year (1964), the price ($18,000), and the VIN (6KGRE16593P448237); for the second car, the make (Ford), the model (Mustang), the color (red), the year (1969), the price ($35,000), and the VIN (5RTYB79055Q569231); and for the third car, the make (Ford), the model (Mustang), the color (red), the year (1974), the price ($15,000), and the VIN (7WMAQ82592J936381)). This is more efficient than having multiple actions in which each action is used to retrieve a single item of information (e.g., (1) for the first car, the make (Ford), (2) for the first car, the model (Mustang), (3) for the first car, the color (red), (4) for the first car, the year (1964), (5) for the first car, the price ($18,000), (6) for the first car, the VIN (6KGRE16593P448237), (7) for the second car, the make (Ford), (8) for the second car, the model (Mustang), (9) for the second car, the color (red), (10) for the second car, the year (1969), (11) for the second car, the price ($35,000), (12) for the second car, the VIN (5RTYB79055Q569231); (13) for the third car, the make (Ford), (14) for the third car, the model (Mustang), (15) for the third car, the color (red), (16) for the third car, the year (1974), (17) for the third car, the price ($15,000), and (18) for the third car, the VIN (7WMAQ82592J936381)).

Returning to FIGS. 1 and 6B, in the method 600, alternatively or additionally, in an implementation, at an operation 614, the processor 120 can be configured to retrieve, in response to a receipt of the first data, a value of the one or more values for the first data. In the illustrative example, the value can be the VIN (6KGRE16593P448237, 5RTYB79055Q569231, and 7WMAQ82592J936381).

In the implementation, at an operation 616, the processor 120 can be configured to cause (N), in response to a retrieval of the value of the one or more values of the first data, a second query to be sent to the second external data source 110. The second query can reference: (1) an information from a definition of a second action to retrieve second data from the second external data source 110 and (2) a value for a second input parameter for the second action. The value of the one or more values for the first data (e.g., VIN (6KGRE16593P448237, 5RTYB79055Q569231, and 7WMAQ82592J936381) can be the value for the second input parameter. The second action can be defined to include an identification of the second external data source 110 (e.g., EngineSpecs). The second action can be defined to include an identification of a second output parameter for the second action (e.g., EngineVIN (Engine[ ])). A name of a second object (e.g., Engine[ ]) can be a value for the second output parameter. The second object can be defined to reference one or more second attributes (e.g., VIN, cylinder, volume, and power). The one or more second attributes can be defined in the second external data source 110. The one or more second attributes can lack being defined in the database subsystem 126. The one or more second attributes can have a data type to be passed by reference rather than by value. The second action can be defined to include an identification of the second input parameter (e.g., VIN (Number)). The second input parameter can reference one or more of the one or more second attributes.

In the implementation, at an operation 618, the processor 120 can be configured to receive (O), in response to the second query, the second data.

In the implementation, additionally, for example, at an operation 620, the processor 120 can be configured to cause, in response to a receipt of the second data, the second data to be presented.

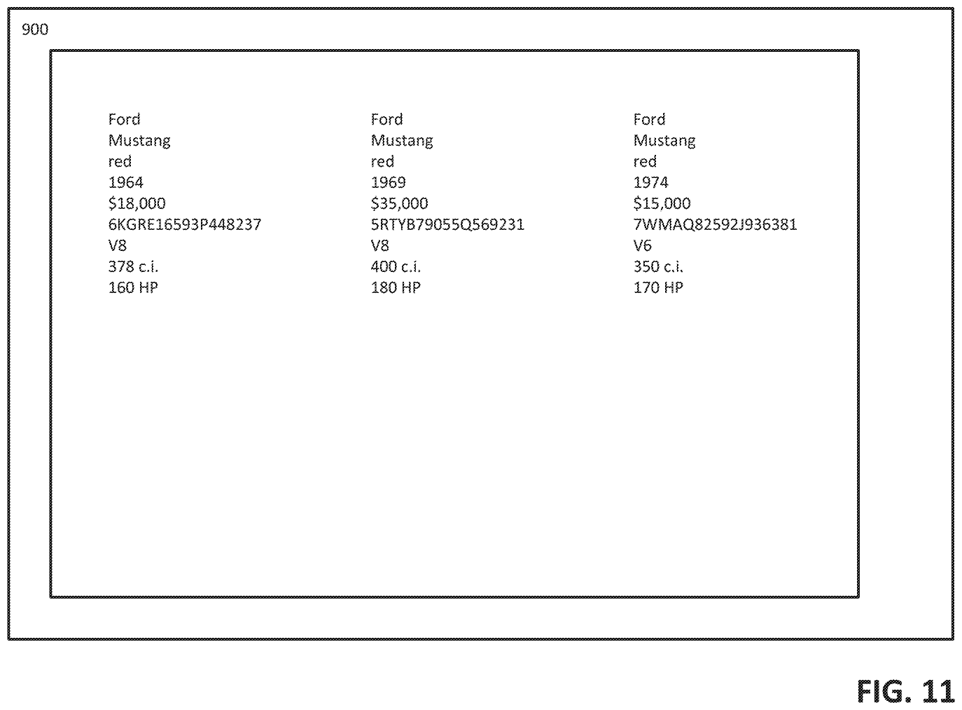

FIG. 11 is a diagram illustrating a second example of the second operation tracking screen 900, according to the disclosed technologies.

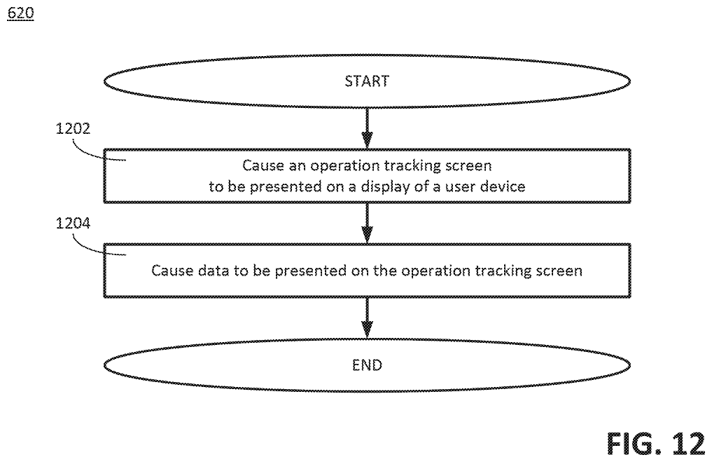

FIG. 12 is a flow diagram illustrating an example of a method 620 for causing second data to be presented, according to the disclosed technologies.

With reference to FIGS. 1, 11, and 12, in the method 620, at an operation 1202, the processor 120 can be configured to cause (P) the second operation tracking screen 900 to be presented on the second display 114 of the second user device 106.

At an operation 1204, the processor 120 can be configured to cause (Q) the second data to be presented on the second operation tracking screen 900. For illustrative purposes herein, the second data can be for engines of the three vintage cars associated with the first data. In the illustrative example, the one or more second attributes associated with the second data can include the VIN for the car, the cylinder configuration of an engine for the car, the volume of cylinders of the engine, and the power of the car. In the illustrative example, the one or more values for the second data can include: (1) for the first car, the VIN (6KGRE16593P448237), the cylinder configuration (V8), the volume (378 c.i.), and the power (160 HP); (2) for the second car, the VIN (5RTYB79055Q569231), the cylinder configuration (V8), the volume (400 c.i.), and the power (180 HP); and (3) for the third car, the VIN (7WMAQ82592J936381), the cylinder configuration (V6), the volume (350 c.i.), and the power (170 H

Various implementations for producing an application to process a sequence of operations and for processing the sequence of operations can include or be implemented in the form of computer-implemented processes and apparatuses for practicing those processes. Implementations also can be implemented in the form of a computer program product having computer program code containing instructions implemented in non-transitory and/or tangible media, such as floppy diskettes, compact disc read-only memories (CD-ROMs), hard drives, universal serial bus (USB) drives, or any other machine readable storage medium, wherein, when the computer program code is loaded into and executed by a computer, the computer becomes an apparatus for practicing implementations for producing an application to process a sequence of operations and for processing the sequence of operations.

Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations for producing an application to process a sequence of operations and for processing the sequence of operations.

When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions.

Implementations can be implemented using hardware that can include a processor, such as a general-purpose microprocessor and/or an application-specific integrated circuit (ASIC) that implements all or part of the techniques according to implementations of the disclosed subject matter in hardware and/or firmware. The processor can be coupled to memory, such as random-access memory (RAM), read-only memory (ROM), flash memory, a hard disk or any other device capable of storing electronic information. The memory can store instructions adapted to be executed by the processor to perform the techniques for producing an application to process a sequence of operations and for processing the sequence of operations.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, thereby to enable others skilled in the art to utilize those implementations as well as various implementations with various modifications as may be suited to the particular use contemplated.

1. A method for producing an action to retrieve data from an external data source, the method comprising:
causing, by a processor, an object to be defined to reference at least one attribute that:
is defined in the external data source,
lacks being defined in a database subsystem, and
has a data type to be passed by reference rather than by value; and
causing, by the processor, the action to retrieve data to be defined to include:
an identification of the external data source,
an identification of an input parameter for the action to retrieve data, wherein the input parameter references at least one of the at least one attribute, and
an identification of an output parameter for the action to retrieve data, wherein a name of the object is a value for the output parameter,
wherein:
the processor is configured to operate a customer relationship management system having the database subsystem and a business process subsystem, and
the action to retrieve data is associated with a sequence of operations to be processed by the business process subsystem.

2. The method of claim 1, wherein the database subsystem comprises a multitenant database.

3. The method of claim 1, wherein the causing the action to retrieve data to be defined comprises:
causing, by the processor, an operation tracking design screen to be presented on a display of a user device, wherein:
the operation tracking design screen includes a first screen area and a second screen area,
the first screen area is a canvas graphical user interface, and
the second screen area includes a graphical control element configured to cause, in response to being selected, a graphical representation to appear in the first screen area, the graphical control element being associated with the action to retrieve data;
receiving, by the processor, a first signal, wherein the first signal indicates a selection of the graphical control element;
causing, by the processor in response to a receipt of the first signal, the graphical representation to appear in the first screen area;
receiving, by the processor, a second signal, wherein the second signal indicates a selection of the graphical representation;
causing, by the processor in response to a receipt of the second signal, a user interface to be presented on the display; and
receiving, by the processor via the user interface, a third signal, wherein the third signal indicates:
the identification of the external data source,
the identification of the input parameter, and
the identification of the output parameter.

4. A non-transitory computer-readable medium storing computer code for producing an action to retrieve data from an external data source, the computer code including instructions to cause a processor to:
cause an object to be defined to reference at least one attribute that:
is defined in the external data source,
lacks being defined in a database subsystem, and
has a data type to be passed by reference rather than by value; and
cause the action to retrieve data to be defined to include:
an identification of the external data source,
an identification of an input parameter for the action to retrieve data, wherein the input parameter references at least one of the at least one attribute, and
an identification of an output parameter for the action to retrieve data, wherein a name of the object is a value for the output parameter,
wherein:
the processor is configured to operate a customer relationship management system having the database subsystem and a business process subsystem, and
the action to retrieve data is associated with a sequence of operations to be processed by the business process subsystem.

5. A system for producing an action to retrieve data from an external data source, the system comprising:
a memory configured to store an object, an action, an input parameter for the action, an output parameter for the action, computer code including instructions to cause a processor to operate a customer relationship management system having a database subsystem and a business process subsystem, and a sequence of operations, associated with the action, to be processed by the business process subsystem; and
the processor configured to:
cause the object to be defined to reference at least one attribute that:
is defined in the external data source,
lacks being defined in the database subsystem, and
has a data type to be passed by reference rather than by value; and
cause the action to retrieve data to be defined to include:
an identification of the external data source,
an identification of the input parameter for the action to retrieve data, wherein the input parameter references at least one of the at least one attribute, and
an identification of the output parameter for the action to retrieve data, wherein a name of the object is a value for the output parameter.

6. The system of claim 5, wherein the database subsystem comprises a multitenant database.

7. A method for retrieving data from an external data source, the method comprising:
receiving, by a processor, a first signal, wherein:
the first signal indicates a value for a first input parameter for a first action to retrieve first data from a first external data source, and
a definition of the first action includes:
an identification of the first external data source,
an identification of a first output parameter for the first action, wherein a name of a first object is a value for the first output parameter, the first object defined to reference at least one first attribute that:
is defined in the first external data source,
lacks being defined in a database subsystem, and
has a data type to be passed by reference rather than by value, and
an identification of the first input parameter, wherein the first input parameter references at least one of the at least one first attribute;
causing, by the processor in response to a receipt of the first signal, a first query to be sent to the first external data source, wherein the first query references:
an information from the definition of the first action, and
the value for the first input parameter; and
receiving, by the processor in response to the first query, the first data, wherein at least one value for the first data is associated with the at least one first attribute,
wherein:
the processor is configured to operate a customer relationship management system having the database subsystem and a business process subsystem, and
the first action is associated with a sequence of operations to be processed by the business process subsystem.

8. The method of claim 7, wherein the database subsystem comprises a multitenant database.

9. The method of claim 7, wherein the receiving the first signal comprises:
causing, by the processor, an operation tracking screen to be presented on a display of a user device, wherein the operation tracking screen has a graphical control element configured to receive the value for the first input parameter; and
receiving, by the processor via the graphical control element, the first signal.

10. The method of claim 7, further comprising:
receiving, by the processor, a second signal, wherein the second signal is configured to cause the first action to be initiated; and
retrieving, by the processor in response to a receipt of the second signal, the information from the definition of the first action, wherein the information includes at least the identification of the first external data source, the identification of the first output parameter, the name of the first object, and the identification of the first input parameter.

11. The method of claim 7, further comprising causing, by the processor in response to a receipt of the first data, the first data to be presented.

12. The method of claim 11, wherein the causing the first data to be presented comprises:
causing, by the processor, an operation tracking screen to be presented on a display of a user device; and
causing, by the processor, the first data to be presented on the operation tracking screen.

13. The method of claim 7, further comprising:
retrieving, by the processor in response to a receipt of the first data, a value of the at least one value for the first data;
causing, by the processor in response to a retrieval of the value of the at least one value for the first data, a second query to be sent to a second external data source, wherein the second query references:
an information from a definition of a second action to retrieve second data from the second external data source, the second action defined to include:
an identification of the second external data source,
an identification of a second output parameter for the second action, wherein a name of a second object is a value for the second output parameter, the second object defined to reference at least one second attribute that:
is defined in the second external data source,
lacks being defined in the database subsystem, and
has the data type to be passed by reference rather than by value, and
an identification of a second input parameter for the second action, wherein the second input parameter references at least one of the at least one second attribute, and
a value for the second input parameter, wherein the value of the at least one value for the first data is the value for the second input parameter; and
receiving, by the processor in response to the second query, the second data,
wherein the second action is associated with the sequence of operations.

14. The method of claim 13, wherein the second external data source is the first external data source.

15. The method of claim 13, further comprising causing, by the processor in response to a receipt of the second data, the second data to be presented.

16. The method of claim 15, wherein the causing the second data to be presented comprises:
causing, by the processor, an operation tracking screen to be presented on a display of a user device; and
causing, by the processor, the second data to be presented on the operation tracking screen.

17. A non-transitory computer-readable medium storing computer code for retrieving data from an external data source, the computer code including instructions to cause a processor to:
receive a signal, wherein:
the signal indicates a value for an input parameter for an action to retrieve the data from the external data source, and
a definition of the action includes:
an identification of the external data source,
an identification of an output parameter for the action, wherein a name of an object is a value for the output parameter, the object defined to reference at least one attribute that:
is defined in the external data source,
lacks being defined in a database subsystem, and
has a data type to be passed by reference rather than by value, and
an identification of the input parameter, wherein the input parameter references at least one of the at least one attribute;
cause, in response to a receipt of the signal, a query to be sent to the external data source, wherein the query references:
an information from the definition of the action, and
the value for the input parameter; and
receive, in response to the query, the data, wherein at least one value for the data is associated with the at least one attribute,
wherein:
the processor is configured to operate a customer relationship management system having the database subsystem and a business process subsystem, and
the action is associated with a sequence of operations to be processed by the business process subsystem.

18. A system for retrieving data from an external data source, the system comprising:
a memory configured to store a signal, a first action, a first input parameter for the first action, a first output parameter for the first action, a first object, computer code including instructions to cause a processor to operate a customer relationship management system having a database subsystem and a business process subsystem, and a sequence of operations, associated with the first action, to be processed by the business process subsystem; and
the processor configured to:
receive the signal, wherein:
the signal indicates a value for the first input parameter for the first action to retrieve first data from a first external data source, and
a definition of the first action includes:
an identification of the first external data source,
an identification of the first output parameter for the first action, wherein a name of the first object is a value for the first output parameter, the first object defined to reference at least one first attribute that:
is defined in the first external data source,
lacks being defined in the database subsystem, and
has a data type to be passed by reference rather than by value, and
an identification of the first input parameter, wherein the first input parameter references at least one of the at least one first attribute;
cause, in response to a receipt of the signal, a first query to be sent to the first external data source, wherein the first query references:
an information from the definition of the first action, and
the value for the first input parameter; and
receive, in response to the first query, the first data, wherein at least one value for the first data is associated with the at least one first attribute.

19. The system of claim 18, wherein the database subsystem comprises a multitenant database.

20. The system of claim 18, wherein:
the memory is further configured to store a second action, a second input parameter for the second action, a second output parameter for the second action, and a second object; and
the processor is further configured to:
retrieve, in response to a receipt of the first data, a value of the at least one value for the first data;
cause, in response to a retrieval of the value of the at least one value for the first data, a second query to be sent to a second external data source, wherein the second query references:
an information from a definition of the second action to retrieve second data from the second external data source, the second action defined to include:
an identification of the second external data source,
an identification of the second output parameter for the second action, wherein a name of the second object is a value for the second output parameter, the second object defined to reference at least one second attribute that:
is defined in the second external data source,
lacks being defined in the database subsystem, and
has the data type to be passed by reference rather than by value, and
an identification of the second input parameter for the second action, wherein the second input parameter references at least one of the at least one second attribute, and
a value for the second input parameter, wherein the value of the at least one value for the first data is the value for the second input parameter; and
receive, in response to the second query, the second data,
wherein the second action is associated with the sequence of operations.
